(19) United States
(12) Patent Application Publication
(10) Pub. No.: US 2014/0019386 A1
(43) Pub. Date: Jan. 16, 2014

(54) Computerized Logical Decision and Learning System

(71) Applicant: Timothy Mitchell, Ocean Shores, WA (US)

(72) Inventor: Timothy Mitchell, Ocean Shores, WA (US)

(21) Appl. No.: 13/842,039

(22) Filed: Mar. 15, 2013

Related U.S. Application Data
(60) Provisional application No. 61/672,103, filed on Jul. 16, 2012.

(51) Int. Cl. G06N 5/02; G06N 99/00

(52) U.S. Cl. CPC G06N 5/02; G06N 99/005
USPC 706/12

(57) ABSTRACT

In various embodiments, a computer-implemented method for decision making and learning is disclosed. The method comprises receiving, by a processor, an alert indicating a change of a monitored system. The method further comprises selecting, by the processor, a statistically best action for responding to the alert and initiating, by the processor, the statistically best action.

### CROSS-REFERENCE TO RELATED APPLICATION

This application claims the benefit, under 35 U.S.C. §119(e), of U.S. provisional patent application No. 61/672,103, filed Jul. 16, 2012, entitled “Computerized Logical Decision and Learning System”, which is hereby incorporated by reference in its entirety.

### BACKGROUND OF THE DISCLOSURE

Current computer systems and applications are limited to preprogrammed responses. The responses are identified and programmed by a programmer. The applications are limited to following the preprogrammed response and are unable to deviate from the preprogrammed responses based on changing conditions or historical data. In order to change the preprogrammed response, a programmer must re-program the system or application. Current systems and applications are reactive and may only respond to conditions that have already occurred. Current applications are unable to proactively predict changing conditions and modify a system to respond to predicted conditions.

### SUMMARY OF THE DISCLOSURE

In various embodiments, a computer-implemented method for decision making and learning is disclosed. The method comprises receiving, by a processor, an alert indicating a change of a monitored system. The method further comprises selecting, by the processor, a statistically best action for responding to the alert and initiating, by the processor, the statistically best action.

In various embodiments, a system for computerized decision making and learning is disclosed. The system comprises a processor and a memory unit. The memory unit is operatively coupled to the processor. The memory unit is configured to store a plurality of instructions. The plurality of instructions is configured to program the processor to receive an alert indicating a change of a monitored system. The processor is further configured to select a statistically best action for responding to the alert and initiate the statistically best action.

In various embodiments, a computer-implemented method for decision making and learning is disclosed. The method comprises receiving, by a processor, an alert indicating a change of a monitored system. The method further comprises selecting, by the processor, a statistically best action for responding to the alert. The statistical best action is determined based on statistical data. The statistical data represents an outcome of one or more prior actions. The method further comprises initiating, by the processor, the statistically best action and determining, by the processor, an outcome of the statistically best action.

### BRIEF DESCRIPTION OF THE DRAWINGS

The features of the various embodiments are set forth with particularity in the appended claims. The various embodiments, however, both as to organization and methods of operation, together with advantages thereof, may best be understood by reference to the following description, taken in conjunction with the accompanying drawings as follows:

FIG. 1 illustrates one embodiment of a computerized logical decision and learning system.

FIG. 2 illustrates one embodiment of a computerized logical decision and learning system process flow.

FIG. 3 illustrates one embodiment of a computer system for implementing a computerized logical decision and learning system.

### DETAILED DESCRIPTION OF THE DISCLOSURE

In various embodiments, a computer-implemented method for decision making and learning is disclosed. The method comprises receiving, by a processor, an alert indicating a change of a monitored system. The method further comprises selecting, by the processor, a statistically best action for responding to the alert and initiating, by the processor, the statistically best action.

In various embodiments, a system for computerized decision making and learning is disclosed. The system comprises a processor and a memory unit. The memory unit is operatively coupled to the processor. The memory unit is configured to store a plurality of instructions. The plurality of instructions is configured to program the processor to receive an alert indicating a change of a monitored system. The processor is further configured to select a statistically best action for responding to the alert and initiate the statistically best action.

In various embodiments, a computer-implemented method for decision making and learning is disclosed. The method comprises receiving, by a processor, an alert indicating a change of a monitored system. The method further comprises selecting, by the processor, a statistically best action for responding to the alert. The statistical best action is determined based on statistical data. The statistical data represents an outcome of one or more prior actions. The method further comprises initiating, by the processor, the statistically best action and determining, by the processor, an outcome of the statistically best action.

Reference will now be made in detail to several embodiments, including embodiments showing example implementations of a computerized logical decision and learning system. Wherever practicable similar or like reference numbers may be used in the figures and may indicate similar or like functionality. The figures depict example embodiments of the disclosed systems and/or methods of use for purposes of illustration only. One skilled in the art will readily recognize from the following description that alternative example embodiments of the structures and methods illustrated herein may be employed without departing from the principles described herein.

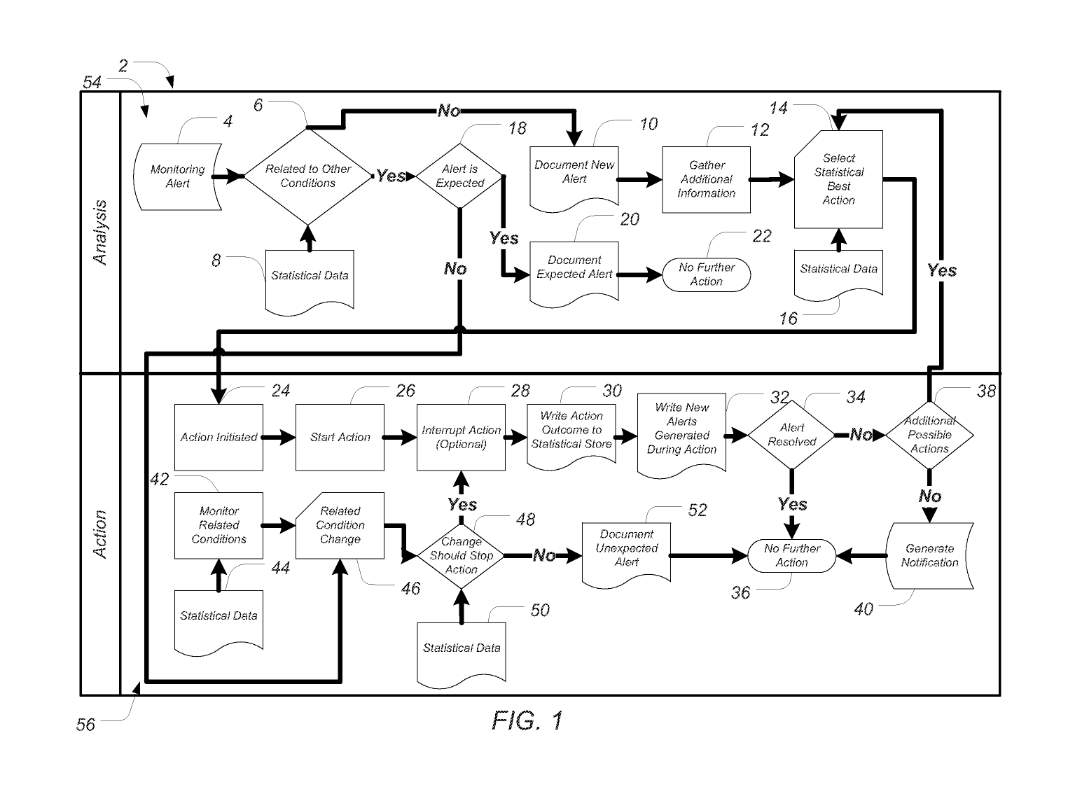

FIG. 1 illustrates one embodiment of a computerized logical decision and learning system 2. The computerized logical decision and learning system 2 may comprise one or more modules to enable the application to adapt to observations and historical data without the input of human programmers. In one embodiment, the computerized logical decision and learning system 2 may perform statistical analysis of one or more conditions within a monitored system or observed target to facilitate adaptation and actions of the monitored system.

In some embodiments, the computerized logical decision and learning system 2 can automatically become more efficient and accurate at diagnosing and predicting the outcome of an action taken by a monitored system in a specification situation by adapting to situational information. In contrast, existing system are limited by the decisions that are provided by the original programmers and cannot automatically adapt to new observation. The logical decision and learning system 2 may change the action taken based on learned information and past experience and is not limited only to pre-programmed responses.

The computerized logical decision and learning system 2 comprises an analysis section 54 and an action section 56. The computerized logical decision and learning system 2 comprises a receiving a monitoring alert 4 from an external process, such as a monitor. A monitor may comprise a system configured to observe and/or control one or more systems and/or processes. For example, a monitor may comprise a repair system, a load monitor, a remote camera, or any other suitable monitor for monitoring a system or objective. The monitoring alert 4 may indicate to the computerized logical decision and learning system 2 that there has been a change in a monitored system or a target objective. The alert 4 may comprise tagged information regarding systems that may be involved in the change in the monitored system or the target objective. A change in the target objective may comprise, for example, a system not responding as expected, an expected change in the system, a trigger event, an expected or unexpected response to an action, and/or any other change in the target objective.

The computerized logical decision and learning system 2 may determine whether the monitoring alert 4 is related to one or more additional conditions 6. The computerized logical decision and learning system 2 may determine a relationship between the monitoring alert 4 and the additional conditions 6 based on statistical data 8. The statistical data 8 may comprise data that has been observed regarding the outcomes of prior actions taken by the computerized logical decision and learning system 2. In some embodiments, the prior actions may have been taken in response to a monitoring alert previously received by the computerized logical decision and learning system 2. The statistical data 8 may comprise a tagging system to identify components and/or systems that a monitored system or action affects in order to distinguish between and correlate information generated by multiple monitors or monitoring systems. If the computerized logical decision and learning system 2 determines that the monitored alert is not related to other conditions and/or alerts previously recorded by the computerized logical decision and learning system 2, the computerized logical decision and learning system 2 documents the monitored alert as a new alert 10.

In some embodiments, the new alert 10 may be added to a statistical data store, such as, for example, the statistical data 8. The documentation of the new alert 10 may indicate that new information has been received that is not related to a currently running action or recently taken action. Information may be logged and tagged by the tagging system with one or more systems related to the new alert 10. After documenting the new alert 10, the computerized logical decision and learning system 2 may gather additional information 12 about the alert, for example, by launching one or more additional monitoring functions. The one or more additional monitoring function may be constantly running, may be scheduled to run, or may simply be executed as needed by the computerized logical decision and learning system 2. The computerized logical decision and learning system 2 may use tagged information regarding the new alert 10 and/or the one or more additional monitoring functions to perform additional investigation regarding the new alert 10.

In some embodiments, the computerized logical decision and learning system 2 may use the gathered additional information 12 to select a statistically best action/response 14 to the monitoring alert 4. The computerized logical decision and learning system 2 may utilize statistical analysis to determine which action typically renders the desired outcome for the monitored alert 4 received from the monitored system. For example, the monitored alert 4 mat indicate a monitored system has stopped responding. The desired outcome may be to return the monitored system to a responsive state. The computerized logical decision and learning system 2 may select an action likely to return the monitored system to a responsive state, such as, for example, restarting the monitored system. The statistical analysis may filter for already attempted actions and may select additional actions or initiate additional attempts if a first action or attempt fails to render the desired outcome. The computerized logical decision and learning system 2 may access statistical data 16 to identify historic actions and results or statistically determined actions and results. In some embodiments, the statistical data 16 and the statistical data 8 may comprise the same statistical data.

In some embodiments, the computerized logical decision and learning system 2 may identify the monitored alert 4 as an expected alert. An expected alert may be an alert that is known to be generated by one or more previous actions initiated by the computerized logical decision and learning system 2. The computerized logical decision and learning system 2 may recognize that some monitored alerts 4 may be the result of actions initiated by the computerized logical decision and learning system 2. The computerized logical decision and learning system 2 may document the expected alert 20. Once the expected alert 20 is documented, no additional action 22 may be required.

In some embodiments, after determining the statistically best action 14, the computerized logical decision and learning system 2 may enter the action phase 56. The action phase 56 may comprise initiating the action 24 selected by the analysis phase 54. The computerized logical decision and learning system 2 may initialize one or more additional monitoring systems to watch for positive or negative responses to the action that will be taken. The computerized logical decision and learning system 2 may begin a separate process for monitoring before initiating the action 24.

The initiated action 24 may be started 26 by sending the action to the external system for implementation. The computerized logical decision and learning system 2 may send instructions to automated systems, such as, for example, control systems or repair systems to initiate an automated action. The computerized logical decision and learning system 2 may send one or more notifications to individuals to take specific actions or to follow specific procedural guidelines.

The initiated action may be interrupted 28 by a secondary action. The computerized logical decision and learning system 2 may determine that a secondary action is necessary as discussed in more detail below. The computerized logical decision and learning system 2 may monitor the outcome of the action taken and may store 30 the outcome of the action in a statistical data store, such as, for example the statistical data store 8. The stored 30 outcome of the initiated action may identify the action taken, the outcome of the action, and whether the outcome was the expected outcome from the action.

The computerized logical decision and learning system 2 may document 32 new alerts that were generated during the action 26 and which were not expected based on the action taken by the external system. The documented 32 new alerts may allow the computerized logical decision and learning system 2 to determine what additional conditions may be associated with a specific action. The associated conditions may then be used to predict what actions are best to respond to a given monitored alert 4 or when to stop an action if conditions change. The documented 32 new alerts may further indicate what alerts should be expected by the computerized logical decision and learning system 2 during the selected action and which alerts requiring interrupting 28 the current action. If the action is repeated in the future, the alert may be documented 20 as an expected alert and statistical information may be updated indicating that the alert is a common expected alert. If the monitored alert 4 has been resolved 34 by the selected action 14, no further action 36 is required by the computerized logical decision and learning system 2. If the computerized logical decision and learning system 2 determines that the alert has not been resolved 34, the computerized logical decision and learning system 2 may determine 38 if additional actions are possible. If additional actions are possible, the computerized logical decision and learning system 2 returns to step 14 and reevaluates the current alert. The computerized logical decision and learning system 2 may determine a next statistical best action 14 for responding to the alert based on the updated statistical data 16. If no additional actions 36 are possible, the computerized logical decision and learning system 2 generates 40 a notification that the monitored alert 4 has not been resolved and that no additional actions are possible. The notification 40 may be sent to an external system or to an operator.

In some embodiments, the computerized logical decision and learning system 2 may monitor 42 one or more related conditions during execution of the statistically best action. The monitored related conditions may be identified by a statistical data 44 indicating historic or statistically related conditions to the action selected 14 by the statistically best action. If a monitored related condition change 46 is detected, the computerized logical decision and learning system 2 determines 48 whether the related condition change 46 requires stopping the current action. If the related condition change 46 does not require a stopping the current action, the computerized logical decision and learning system 2 documents 52 the unexpected alert and takes no further action 36. If the computerized logical decision and learning system 2 determines that the related condition change 46 requires interrupting 28 the current action, the computerized logical decision and learning system 2 interrupts 28 the current action and begins a new action based on the related condition change 46. The computerized logical decision and learning system 2 may determine 48 whether the current action should be stopped based on statistical data 50 indicating previous related condition changes and the affects of those changes on the selected action. Although the statistical data is shown as four distinct data sets, those skilled in the art will recognize that the illustrated statistic data sets may comprise a single statistical data set.

For example, in some embodiments, the computerized logical decision and learning system 2 may be implemented to provide adaptive repair of computerized systems. Computer systems may regularly suffer from failures that cause the software and/or the system to not respond as anticipated or to not respond at all. A software system may have a programmed response that may be followed to correct the errors that caused the system to stop responding as anticipated. A computerized logical decision and learning system 2 may be able to follow a traditional programmed response to repair a system. In some embodiments, the computerized logical decision and learning system may adapt a repair response to the specific website based on historical and statistical information.

For example, a Windows Operating System (OS) website may be hosted in an Internet Information Service (IIS) application. If a website stops responding as anticipated, a repair response may follow a linear path to attempt a repair. The linear repair sequence may start by initiating a repair response to restart the specific site. If restarting the specific site fails to correct the error, the repair response may restart the ISS application. If restarting both the website and the ISS application fails to correct the error, the repair response may restart a machine hosting the ISS.

In some embodiments, the computerized logical decision and learning system 2 may adapt a repair response to a specific website hosted by the ISS application. Over a period of time, the computerized logical decision and learning system 2 may learn what repairs were successful for the specific website. In some embodiments, the logical decision and learning system 2 may follow the linear repair response discussed above. In some embodiments, the computerized logical decision and learning system 2 may document which repairs have succeeded or failed and may adapt the repair response based on the observed information. By gathering statistical information, such as previously successful or unsuccessful repairs, the computerized logical decision and learning system 2 can skip steps that statistically fail to fix a specific error or site, and therefore can reduce the time that a system spends offline.

In some embodiments, the computerized logical decision and learning system 2 may also compare statistical successes or failures to additional information about the type of repair being attempted. For example, if a website stops responding, the computerized logical decision and learning system 2 may document that restarting the server hosting the website is typically the repair that works when memory utilization is high. The computerized logical decision and learning system 2 may also document that restarting the specific site is typically the repair that works when memory utilization is low. The computerized logical decision and learning system 2 may dynamically change the repair response based on additional information about a system without the need for input from a programmer. The statistics may be developed over time and may provide a repair response that will take the statistically best action to achieve the fastest repair time possible.

As another example, the computerized logical decision and learning system 2 may be implemented in conjunction with a predictive application load system. A common method for increasing the number of users that can access a web-based or server-based application is to increase the number of servers that host the application. A predictive load application may increase or decrease the number of servers that host a web-based or server-based application based on the current number of users. Current predictive load applications cannot predict future load demands. By combining a predictive load application with the computerized logical decision and learning system 2, the predictive load application may be able to predict future load demands based on business events and/or historical usage. By predicting future load, the predictive load application and the computerized logical decision and learning system 2 may provide proactive management of resources, increasing user experience and efficiency.

For example, in one embodiment, a predictive load application, such as, for example, a monitoring tool, may comprise a programmed response. The monitoring tool may observe a load generated by a specific application on one or more servers and may, at a given load threshold, increase or decrease the number of servers currently hosting the application. The programmed response of the monitoring tool is limited to the currently visible load on the servers and/or the application and can only react to changes in load that are currently occurring. The preprogrammed response is reactive and may allow an application and/or server to become overloaded if loads change rapidly. For example, over the course of a weekend, fewer phone calls may be made to and from a business that is closed. A preprogrammed, reactive monitoring system may reduce the number of servers running a call application due to the low load on the application. However, on Monday morning, the business may reopen and multiple users may attempt to send or receive calls over the call application. Because the number of servers executing the call application has been reduced, the call application will run slowly and deliver a poor user experience until the monitoring system has added new servers to support the current increase in load.

In one embodiment, the monitoring tool may be further limited to a single application monitored by the monitoring tool and cannot predict load changes in other applications and/or servers based on a change in the number of servers executing a specific application. For example, a monitoring tool may increase the number of servers running a call application monitored by the monitoring tool. The servers running the call application may be dependent on supporting services or applications, such as, for example, one or more databases and/or a customer relationship management (CRM) system. The increase in the number of servers executing the call application may simply shift the increased load from the call application servers to the support applications. A reactive monitoring system cannot predict the shift in load and instead may reactively increase the number of supporting applications after the increase in the call application. The supporting applications will be overloaded during the period between increasing the number of servers executing the call application and increasing the number of servers executing support applications. The call application will continue to perform slowly and will continue to deliver a poor user experience until all of the supporting applications have had a reactive increase in capacity.

In some embodiments, a computerized logical decision and learning system 2 may be coupled to a monitoring tool to adapt the monitoring tool based on statistical information. For example, over time, the computerized logical decision and learning system 2 may determine that a call application experiences increased load on Monday mornings and may cause the monitoring tool to proactively increase the number of servers providing the call application prior to the increase in load. In some embodiments, the computerized logical decision and learning system 2 may identify related applications and may predict that when the call application capacity increases, such as due to an increase in the number of servers executing the call application, additional database and CRM capacity is required. The computerized logical decision and learning system 2 may predictively increase the capacity of the call application and the related/supporting systems and applications prior to an increase in demand, such as the historic increase on Monday mornings. The computerized logical decision and learning system 2 may also increase the capacity of supporting applications and systems, such as the database or CRM system, when an unforeseen increase in the load of the monitored application, such as, for example, the call application, causes the monitoring tool to increase the number of servers running the monitored application.

In some embodiments, a computerized logical decision and learning system 2 may be configured to adapt statistical information and correlate with additional factors without the need for programmers to change an existing response or code. The computerized logical decision and learning system 2 may be used in any environment in which adaptive or predictive responses may be beneficial. For example, in one embodiment, the computerized logical decision and learning system 2 may be configured to identify information that is commonly requested by an application, system, and/or user. The computerized logical decision and learning system 2 may learn the types of information that are commonly requested by, for example, a specific user or user type and may prioritize commonly requested information in responses to the specific user. For example, a business manager may request information about a product and may be interested in a first set of information. A technology professional may request information about the same product, but may be interested in a second set of information. The computerized logical decision and learning system 2 may learn from the information requests made by the users, such as other product information requests, and may provide a specific type of information to a specific user, for example, delivering the first set of information to the business manager and the second set of information to the technology specialist. In some embodiments, the computerized logical decision and learning system 2 may recommend applications or products better suited to the needs of a specific individual based on the statistically common responses for that or similar users.

In some embodiments, the computerized logical decision and learning system 2 may be coupled to a system configured to provide medical assistance. The computerized logical decision and learning system 2 may be configured to observe and adapt to interactions between medical professionals and patients. The computerized logical decision and learning system 2 may provide suggestions to the medical professionals and/or control robotic systems to provide medical or emergency aid. The computerized logical decision and learning system 2 may collect observations and information from procedures performed by specialists and may enable a robotic system to perform the procedures when a specialist is not available. In some embodiments, the key to performing an advanced procedure without human interaction may be the ability to predict the outcome of an action before the action is performed. The computerized logical decision and learning system 2 may provide adaptive and predictive logic to any software or robotic system, such as, for example, a robotic medical system.

In some embodiments, the computerized logical decision and learning system 2 may be configured to provide suggestions and/or to direct a logistical or tactical response. The computerized logical decision and learning system 2 may observe the responses and movements of, for example, combatants in the field. The computerized logical decision and learning system 2 may be configured to direct troops or friendly unmanned autonomous vehicles (UAVs). The computerized logical decision and learning system 2 may use observed combatant responses to direct troops or UAVs to exploit weaknesses in enemy reactions. For example, in response to seeing one or more UAVs, a group of terrorist or combatants may move away from an area occupied by the UAVs. By observing the terrorist response, the computerized logical decision and learning system 2 may predict the most likely path of retreat for the terrorist and may place unmanned and/or manned ground vehicles in the most likely path of retreat prior to using the UAVs. By predicting the enemy response, the computerized logical decision and learning system 2 may manipulate the reactions of enemy troops advantageously.

In some embodiments, the computerized logical decision and learning system 2 may predict the number of times a specific tactic may be successful before the tactic must be changed. For example, after several groups of terrorist are driven into an ambush by retreating from the UAVs, a group of terrorist may learn to stay in place when observing UAVs in the area. In response to this change in behavior, the computerized logical decision and learning system 2 may change tactics. For example, the computerized logical decision and learning system 2 may direct UAVs or other vehicles to hold the terrorist in place while other forces respond. As another example, the computerized logical decision and learning system 2 may direct the UAV to leave the area in order to give a false sense that the threat has passed. By changing tactics based on observed behavior, the computerized logical decision and learning system 2 may manipulate a situation advantageously.

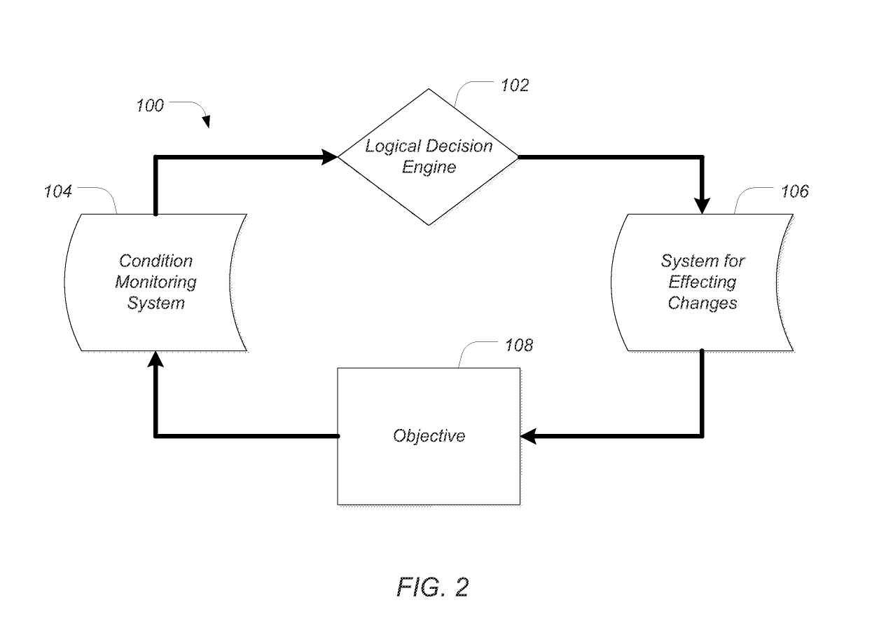

In some embodiments, the computerized logical decision and learning system 2 may select the most favorable action available to achieve the best outcome based on historical actions taken. The computerized logical decision and learning system 2 may be part of a separate system that can monitor and change a system or objective. FIG. 2 illustrates one embodiment of a computerized logical decision and learning system process flow 100. A computerized logical decision and learning system 102 may monitor the condition of a monitored system 104. The monitored system 104 may indicate condition changes to the computerized logical decision and learning system 102. The computerized logical decision and learning system 102 may determine a statistically best action for responding to the change in conditions of the monitored system 104. For example, the computerized logical decision and learning system 102 may determine a statistically best action according to the process shown in FIG. 1.

In some embodiments, the computerized logical decision and learning system 102 may initiate an action in a system for effecting changes 106 of the monitored system 104. The system for effecting changes 106 may comprise, for example, a repair system and/or a control system. The system for effecting changes 106 may initiate one or more actions identified by the computerized logical decision and learning system 102. The system for effecting changes 106 may change the condition of the monitored system 104 through the one or more actions to reach an objective 108. Once the objective 108 has been obtained, the monitored system may be in a new condition. The new condition may be provided to the computerized logical decision and learning system 102, which may generate one or more additional actions if the condition of the monitored system is not the expected condition.

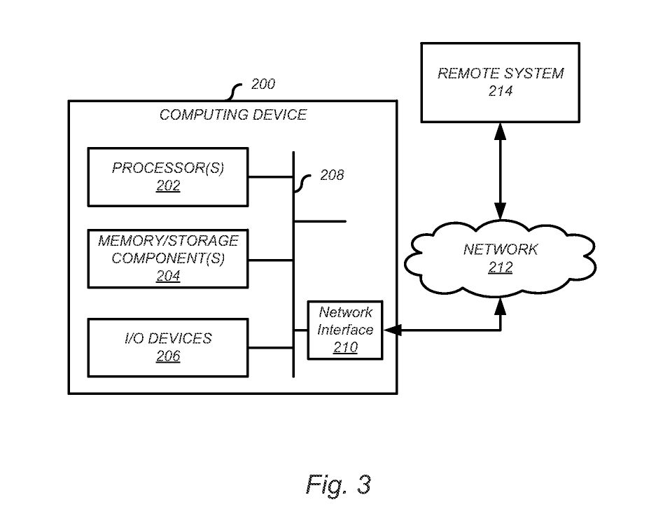

FIG. 3 illustrates one embodiment of a computing device 200 which can be used in one embodiment of the computerized logical decision and learning system 2. For the sake of clarity, the computing device 200 is shown and described here in the context of a single computing device. It is to be appreciated and understood, however, that any number of suitably configured computing devices can be used to implement any of the described embodiments. For example, in at least some implementation, multiple communicatively linked computing devices are used. One or more of these devices can be communicatively linked in any suitable way such as via one or more networks (LANs), one or more wide area networks (WANs) or any combination thereof.

In this example, the computing device 200 comprises one or more processor circuits or processing units 202, on or more memory circuits and/or storage circuit component(s) 204 and one or more input/output (I/O) circuit devices 206. Additionally, the computing device 200 comprises a bus 208 that allows the various circuit components and devices to communicate with one another. The bus 208 represents one or more of any of several types of bus structures, including a memory bus or local bus using any of a variety of bus architectures. The bus 208 may comprise wired and/or wireless buses.

The processing unit 202 may be responsible for executing various software programs such as system programs, applications programs, and/or module to provide computing and processing operations for the computing device 200. The processing unit 202 may be responsible for performing various voice and data communications operations for the computing device 200 such as transmitting and receiving voice and data information over one or more wired or wireless communication channels. Although the processing unit 202 of the computing device 200 includes single processor architecture as shown, it may be appreciated that the computing device 200 may use any suitable processor architecture and/or any suitable number of processors in accordance with the described embodiments. In one embodiment, the processing unit 200 may be implemented using a single integrated processor.

The processing unit 202 may be implemented as a host central processing unit (CPU) using any suitable processor circuit or logic device (circuit), such as a as a general-purpose processor. The processing unit 202 also may be implemented as a chip multiprocessor (CMP), dedicated processor, embedded processor, media processor, input/output (I/O) processor, coprocessor, microprocessor, controller, microcontroller, application specific integrated circuit (ASIC), field programmable gate array (FPGA), programmable logic device (PLD), or other processing device in accordance with the described embodiments.

As shown, the processing unit 202 may be coupled to the memory and/or storage component(s) 204 through the bus 208. The memory bus 208 may comprise any suitable interface and/or bus architecture for allowing the processing unit 202 to access the memory and/or storage component(s) 204. Although the memory and/or storage component(s) 204 may be shown as being separate from the processing unit 202 for purposes of illustration, it is worthy to note that in various embodiments some portion or the entire memory and/or storage component(s) 204 may be included on the same integrated circuit as the processing unit 202. Alternatively, some portion or the entire memory and/or storage component(s) 204 may be disposed on an integrated circuit or other medium (e.g., hard disk drive) external to the integrated circuit of the processing unit 202. In various embodiments, the computing device 200 may comprise an expansion slot to support a multimedia and/or memory card, for example.

The memory and/or storage component(s) 204 represent one or more computer-readable media. In some embodiments, the computer-readable media may comprise non-transitory computer readable-media. The memory and/or storage component(s) 204 may be implemented using any computer-readable media capable of storing data such as volatile or non-volatile memory, removable or non-removable memory, erasable or non-erasable memory, writeable or re-writeable memory, and so forth. The memory and/or storage component(s) 204 may comprise volatile media (e.g., random access memory (RAM)) and/or nonvolatile media (e.g., read only memory (ROM), Flash memory, optical disks, magnetic disks and the like). The memory and/or storage component(s) 204 may comprise fixed media (e.g., RAM, ROM, a fixed hard drive, etc.) as well as removable media (e.g., a Flash memory drive, a removable hard drive, an optical disk, etc.). Examples of computer-readable storage media may include, without limitation, RAM, dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory, ovonic memory, ferroelectric memory, silicon-oxide-nitride-oxide-silicon (SONOS) memory, magnetic or optical cards, or any other type of media suitable for storing information.

The one or more I/O devices 206 allow a user to enter commands and information to the computing device 200, and also allow information to be presented to the user and/or other components or devices. Examples of input devices include a keyboard, a cursor control device (e.g., a mouse), a microphone, a scanner, biometric sensors, and the like. Examples of output devices include a display device (e.g., a monitor or projector, speakers, a printer, a network card, etc.). The computing device 200 may comprise an alphanumeric keypad coupled to the processing unit 202. The keypad may comprise, for example, a QWERTY key layout and an integrated number dial pad. The computing device 200 may comprise a display coupled to the processing unit 202. The display may comprise any suitable visual interface for displaying content to a user of the computing device 4000. In one embodiment, for example, the display may be implemented by a liquid crystal display (LCD) such as a touch-sensitive color (e.g., 76-bit color) thin-film transistor (TFT) LCD screen. The touch-sensitive LCD may be used with a stylus and/or a handwriting recognizer program.

The processing unit 202 may be arranged to provide processing or computing resources to the computing device 200. For example, the processing unit 202 may be responsible for executing various software programs including system programs such as operating system (OS) and application programs. System programs generally may assist in the running of the computing device 200 and may be directly responsible for controlling, integrating, and managing the individual hardware components of the computer system. The OS may be implemented, for example, as a Microsoft® Windows OS, Symbian OS™, Embedix OS, Linux OS, Binary Run-time Environment for Wireless (BREW) OS, JavaOS, Android OS, Apple OS or other suitable OS in accordance with the described embodiments. The computing device 200 may comprise other system programs such as device drivers, programming tools, utility programs, software libraries, application programming interfaces (APIs), and so forth.

The computer 200 also includes a network interface 210 coupled to the bus 208. The network interface 210 provides a two-way data communication coupling to a local network 212. For example, the network interface 210 may be a digital subscriber line (DSL) modem, satellite dish, an integrated services digital network (ISDN) card or other data communication connection to a corresponding type of telephone line. As another example, the communication interface 210 may be a local area network (LAN) card effecting a data communication connection to a compatible LAN. Wireless communication means such as internal or external wireless modems may also be implemented.

In any such implementation, the network interface 210 sends and receives electrical, electromagnetic or optical signals that carry digital data streams representing various types of information, such as the selection of goods to be purchased, the information for payment of the purchase, or the address for delivery of the goods. The network interface 210 typically provides data communication through one or more networks to other data devices. For example, the network interface 210 may effect a connection through the local network to an Internet Host Provider (ISP) or to data equipment operated by an ISP. The ISP in turn provides data communication services through the internet (or other packet-based wide area network). The local network and the internet both use electrical, electromagnetic or optical signals that carry digital data streams. The signals through the various networks and the signals on the network interface 210, which carry the digital data to and from the computer system 400, are exemplary forms of carrier waves transporting the information.

The computer 200 can send messages and receive data, including program code, through the network(s) and the network interface 210. In the Internet example, a server might transmit a requested code for an application program through the internet, the ISP, the local network (the network 212) and the network interface 210. In accordance with the present disclosure, one such downloaded application provides for the identification and analysis of a prospect pool and analysis of marketing metrics. The received code may be executed by processor 204 as it is received, and/or stored in storage device 210, or other non-volatile storage for later execution. In this manner, computer 200 may obtain application code in the form of a carrier wave.

In various embodiments, a computer-implemented method for decision making and learning is disclosed. The method may comprise receiving, by a processor, an alert indicating a change of a monitored system. The method may further comprise selecting, by the processor, a statistically best action for responding to the alert and initiating, by the processor, the statistically best action. In some embodiments, the computer-implemented method may comprise selecting, by the processor, the statistically best action based on statistical data. Selection of the statistically best action may be based on statistical data representative of an outcome of one or more prior actions.

In some embodiments, the computer-implemented method may further comprise identifying, by the processor, at least one related condition of the monitored system. The related condition changes in response to the statistically best action. The at least one related condition may be monitored to detect a change in response to the statistically best action. The processor may interrupt the statistically best action in response to the change in the at least one related condition. An outcome of the statistically best action may be determined. The processor may store the outcome of the statistically best action. In some embodiments, the processor may determine at least one additional action for responding to the alert based on the outcome of the statistically best action and may initiate the at least one additional action.

In various embodiments, a system for computerized decision making and learning is disclosed. The system may comprise a processor and a memory unit operatively coupled to the processor. The memory unit may be configured to store a plurality of instructions. The plurality of instructions may be configured to program the processor to: receive an alert indicating a change of a monitored system; select a statistically best action for responding to the alert; and initiate the statistically best action. The processor may select the statistically best action based on statistical data. The statistical data may be representative of an outcome of one or more prior actions.

In some embodiments, the system identifies at least one related condition. The related condition may change in response to the statistically best action. The processor may be configured to monitor the at least one related condition to detect a change in response to the statistically best action. The processor may be configured to interrupt the statistically best action in response to the change in the at least one related condition. In some embodiments, the processor may be configured to determine an outcome of the statistically best action. The processor may be configured to store the outcome of the statistically best action. In some embodiments, the processor may be configured to determine at least one additional action for responding to the alert based on the outcome of the statistically best action and initiate the at least one additional action.

In various embodiments, a computer-implemented method for decision making and learning is disclosed. The method comprises receiving, by a processor, an alert indicating a change of a monitored system. The processor selects a statistically best action for responding to the alert. The statistically best action is determined based on statistical data. The statistical data represents an outcome of one or more prior actions. The processor may initiate the statistically best action and may determine an outcome of the statistically best action. In some embodiments, the processor may determine at least one additional action for responding to the alert based on the outcome of the statistically best action. The processor may initiate the at least one additional action and may determine an outcome of the at least one additional action.

Various embodiments may be described herein in the general context of computer executable instructions, such as software, program modules, and/or engines being executed by a computer. Generally, software, program modules, and/or engines include any software element arranged to perform particular operations or implement particular abstract data types. Software, program modules, and/or engines can include routines, programs, objects, components, data structures and the like that perform particular tasks or implement particular abstract data types. An implementation of the software, program modules, and/or engines components and techniques may be stored on and/or transmitted across some form of computer-readable media. In this regard, computer-readable media can be any available medium or media useable to store information and accessible by a computing device. Some embodiments also may be practiced in distributed computing environments where operations are performed by one or more remote processing devices that are linked through a communications network. In a distributed computing environment, software, program modules, and/or engines may be located in both local and remote computer storage media including memory storage devices.

Although some embodiments may be illustrated and described as comprising functional components, software, engines, and/or modules performing various operations, it can be appreciated that such components or modules may be implemented by one or more hardware components, software components, and/or combination thereof. The functional components, software, engines, and/or modules may be implemented, for example, by logic (e.g., instructions, data, and/or code) to be executed by a logic device (e.g., processor). Such logic may be stored internally or externally to a logic device on one or more types of computer-readable storage media. In other embodiments, the functional components such as software, engines, and/or modules may be implemented by hardware elements that may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Examples of software, engines, and/or modules may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

In some cases, various embodiments may be implemented as an article of manufacture. The article of manufacture may include a non-transitory computer readable storage medium arranged to store logic, instructions and/or data for performing various operations of one or more embodiments. In various embodiments, for example, the article of manufacture may comprise a magnetic disk, optical disk, flash memory or firmware containing computer program instructions suitable for execution by a general purpose processor or application specific processor. The embodiments, however, are not limited in this context.

The functions of the various functional elements, logical blocks, modules, and circuits elements described in connection with the embodiments disclosed herein may be implemented in the general context of computer executable instructions, such as software, control modules, logic, and/or logic modules executed by the processing unit. Generally, software, control modules, logic, and/or logic modules comprise any software element arranged to perform particular operations. Software, control modules, logic, and/or logic modules can comprise routines, programs, objects, components, data structures and the like that perform particular tasks or implement particular abstract data types. An implementation of the software, control modules, logic, and/or logic modules and techniques may be stored on and/or transmitted across some form of computer-readable media. In this regard, computer-readable media can be any available medium or media useable to store information and accessible by a computing device. Some embodiments also may be practiced in distributed computing environments where operations are performed by one or more remote processing devices that are linked through a communications network. In a distributed computing environment, software, control modules, logic, and/or logic modules may be located in both local and remote computer storage media including memory storage devices.

Additionally, it is to be appreciated that the embodiments described herein illustrate example implementations, and that the functional elements, logical blocks, modules, and circuits elements may be implemented in various other ways which are consistent with the described embodiments. Furthermore, the operations performed by such functional elements, logical blocks, modules, and circuits elements may be combined and/or separated for a given implementation and may be performed by a greater number or fewer number of components or modules. As will be apparent to those of skill in the art upon reading the present disclosure, each of the individual embodiments described and illustrated herein has discrete components and features which may be readily separated from or combined with the features of any of the other several aspects without departing from the scope of the present disclosure. Any recited method can be carried out in the order of events recited or in any other order which is logically possible.

It is worthy to note that any reference to “one embodiment” or “an embodiment” means that a particular feature, structure, or characteristic described in connection with the embodiment is comprised in at least one embodiment. The appearances of the phrase “in one embodiment” or “in one aspect” in the specification are not necessarily all referring to the same embodiment.

Unless specifically stated otherwise, it may be appreciated that terms such as “processing,” “computing,” “calculating,” “determining,” or the like, refer to the action and/or processes of a computer or computing system, or similar electronic computing device, such as a general purpose processor, a DSP, ASIC, FPGA or other programmable logic device, discrete gate or transistor logic, discrete hardware components, or any combination thereof designed to perform the functions described herein that manipulates and/or transforms data represented as physical quantities (e.g., electronic) within registers and/or memories into other data similarly represented as physical quantities within the memories, registers or other such information storage, transmission or display devices.

It is worthy to note that some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, also may mean that two or more elements are not in direct contact with each other, but yet still co-operate or interact with each other. With respect to software elements, for example, the term “coupled” may refer to interfaces, message interfaces, application program interface (API), exchanging messages, and so forth.

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits ASICs, FPGAs, DSPs, or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

In some instances, one or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

In certain cases, use of a system or method may occur in a territory even if components are located outside the territory. For example, in a distributed computing context, use of a distributed computing system may occur in a territory even though parts of the system may be located outside of the territory (e.g., relay, server, processor, signal-bearing medium, non-transitory medium, transmitting computer, receiving computer, etc. located outside the territory).

Although various embodiments have been described herein, many modifications, variations, substitutions, changes, and equivalents to those embodiments may be implemented and will occur to those skilled in the art. Also, where materials are disclosed for certain components, other materials may be used. It is therefore to be understood that the foregoing description and the appended claims are intended to cover all such modifications and variations as falling within the scope of the disclosed embodiments. The following claims are intended to cover all such modification and variations.

In summary, numerous benefits have been described which result from employing the concepts described herein. The foregoing description of the one or more embodiments has been presented for purposes of illustration and description. It is not intended to be exhaustive or limiting to the precise form disclosed. Modifications or variations are possible in light of the above teachings. The one or more embodiments were chosen and described in order to illustrate principles and practical application to thereby enable one of ordinary skill in the art to utilize the various embodiments and with various modifications as are suited to the particular use contemplated. It is intended that the claims submitted herewith define the overall scope.

Various aspects of the subject matter described herein are set out in the following numbered clauses:

1. A computer-implemented method for decision making and learning, the method comprising: receiving, by a processor, an alert indicating a change of a monitored system; selecting, by the processor, a statistically best action for responding to the alert; and initiating, by the processor, the statistically best action.

2. The computer-implemented method of clause 1, comprising selecting, by the processor, the statistically best action based on statistical data.

3. The computer-implemented method of clause 2, comprising selecting, by the processor, the statistically best action based on statistical data representative of an outcome of one or more prior actions.

4. The computer-implemented method of clause 1, comprising identifying, by the processor, at least one related condition of the monitored system, wherein the related condition changes in response to the statistically best action.

5. The computer-implemented method of clause 4, comprising monitoring, by the processor, the at least one related condition to detect a change in response to the statistically best action.

6. The computer-implemented method of clause 5, comprising interrupting, by the processor, the statistically best action in response to the change in the at least one related condition.

7. The computer-implemented method of clause 1, comprising determining, by the processor, an outcome of the statistically best action.

8. The method of clause 8, comprising storing, by the processor, the outcome of the statistically best action.

9. The computer-implemented method of clause 7, comprising: determining, by the processor, at least one additional action for responding to the alert based on the outcome of the statistically best action; and initiating, by the processor, the at least one additional action.

10. A system for computerized decision making and learning comprising: a processor; and a memory unit operatively coupled to the processor, wherein the memory unit is configured to store a plurality of instructions, and wherein the plurality of instructions is configured to program the processor to: receive an alert indicating a change of a monitored system; select a statistically best action for responding to the alert; and initiate the statistically best action.

11. The system of clause 10, wherein the processor selects the statistically best action based on statistical data.

12. The system of clause 11, wherein the statistical data is representative of an outcome of one or more prior actions.

13. The system of clause 10, wherein the processor is configured to identify at least one related condition, wherein the related condition changes in response to the statistically best action.

14. The system of clause 13, wherein the processor is configured to monitor the at least one related condition to detect a change in response to the statistically best action.

15. The system of clause 14, wherein the processor is configured to interrupt the statistically best action in response to the change in the at least one related condition.

16. The system of clause 10, wherein the processor is configured to determine an outcome of the statistically best action.

17. The system of clause 16, wherein the processor is configured to store the outcome of the statistically best action.

18. The system of clause 16, wherein the processor is configured to: determine at least one additional action for responding to the alert based on the outcome of the statistically best action; and initiate the at least one additional action.

19. A computer-implemented method for decision making and learning, the method comprising: receiving, by a processor, an alert indicating a change of a monitored system; selecting, by the processor, a statistically best action for responding to the alert, wherein the statistically best action is determined based on statistical data, and wherein the statistical data represents an outcome of one or more prior actions; initiating, by the processor, the statistically best action; and determining, by the processor, an outcome of the statistically best action.

20. The computer-implemented method of clause 19, comprising: determining, by the processor, at least one additional action for responding to the alert based on the outcome of the statistically best action; and initiating, by the processor, the at least one additional action; and determining, by the processor, an outcome of the at least one additional action.

What is claimed is:

1. A computer-implemented method for decision making and learning, the method comprising:
receiving, by a processor, an alert indicating a change of a monitored system;
selecting, by the processor, a statistically best action for responding to the alert; and
initiating, by the processor, the statistically best action.

2. The computer-implemented method of claim 1, comprising selecting, by the processor, the statistically best action based on statistical data.

3. The computer-implemented method of claim 2, comprising selecting, by the processor, the statistically best action based on statistical data representative of an outcome of one or more prior actions.

4. The computer-implemented method of claim 1, comprising identifying, by the processor, at least one related condition of the monitored system, wherein the related condition changes in response to the statistically best action.

5. The computer-implemented method of claim 4, comprising monitoring, by the processor, the at least one related condition to detect a change in response to the statistically best action.

6. The computer-implemented method of claim 5, comprising interrupting, by the processor, the statistically best action in response to the change in the at least one related condition.

7. The computer-implemented method of claim 1, comprising determining, by the processor, an outcome of the statistically best action.

8. The method of claim 8, comprising storing, by the processor, the outcome of the statistically best action.

9. The computer-implemented method of claim 7, comprising:
determining, by the processor, at least one additional action for responding to the alert based on the outcome of the statistically best action; and
initiating, by the processor, the at least one additional action.

10. A system for computerized decision making and learning comprising:
a processor; and
a memory unit operatively coupled to the processor, wherein the memory unit is configured to store a plurality of instructions, and wherein the plurality of instructions is configured to program the processor to:
receive an alert indicating a change of a monitored system;
select a statistically best action for responding to the alert; and
initiate the statistically best action.

11. The system of claim 10, wherein the processor selects the statistically best action based on statistical data.

12. The system of claim 11, wherein the statistical data is representative of an outcome of one or more prior actions.

13. The system of claim 10, wherein the processor is configured to identify at least one related condition, wherein the related condition changes in response to the statistically best action.

14. The system of claim 13, wherein the processor is configured to monitor the at least one related condition to detect a change in response to the statistically best action.

15. The system of claim 14, wherein the processor is configured to interrupt the statistically best action in response to the change in the at least one related condition.

16. The system of claim 10, wherein the processor is configured to determine an outcome of the statistically best action.

17. The system of claim 16, wherein the processor is configured to store the outcome of the statistically best action.

18. The system of claim 16, wherein the processor is configured to:
determine at least one additional action for responding to the alert based on the outcome of the statistically best action; and
initiate the at least one additional action.

19. A computer-implemented method for decision making and learning, the method comprising:
receiving, by a processor, an alert indicating a change of a monitored system;
selecting, by the processor, a statistically best action for responding to the alert, wherein the statistically best action is determined based on statistical data, and wherein the statistical data represents an outcome of one or more prior actions;
initiating, by the processor, the statistically best action; and
determining, by the processor, an outcome of the statistically best action.

20. The computer-implemented method of claim 19, comprising:
determining, by the processor, at least one additional action for responding to the alert based on the outcome of the statistically best action; and
initiating, by the processor, the at least one additional action; and
determining, by the processor, an outcome of the at least one additional action.
